(19) United States
(12) Patent Application Publication
(10) Pub. No.: US 2026/0086744 A1
(43) Pub. Date: Mar. 26, 2026

(54) IMAGE PROCESSING DEVICE, IMAGE PRINT SYSTEM, AND NON-TRANSITORY COMPUTER-READABLE STORAGE MEDIUM STORING IMAGE PROCESSING PROGRAM

(71) Applicant: SEIKO EPSON CORPORATION, TOKYO (JP)

(72) Inventors: Takuya ONO, SHIOJIRI-SHI (JP); Takahiro KAMADA, MATSUMOTO-SHI (JP); Mitsuhiro YAMASHITA, MATSUMOTO-SHI (JP); Yuko YAMAMOTO, SHIOJIRI-SHI (JP)

(21) Appl. No.: 19/338,065

(22) Filed: Sep. 24, 2025

(30) Foreign Application Priority Data
Sep. 26, 2024 (JP) 2024-166996

(51) Int. Cl. G06F 3/12; G06K 15/02

(52) U.S. Cl. CPC G06F 3/1208; G06F 3/1256; G06K 15/1823; G06K 15/1836

(57) ABSTRACT

Image data of an image to be printed on a print medium is input, and a print condition that is a condition for printing on the print medium is acquired. A method of a bump representation when the image data is processed is selected from the acquired print condition, and a printed material is previewed using the selected method of the bump representation.

The present application is based on, and claims priority from JP Application Serial Number 2024-166996, filed Sep. 26, 2024, the disclosure of which is hereby incorporated by reference herein in its entirety.

### BACKGROUND

### 1. Technical Field

The present disclosure relates to a technique for appropriately representing a bump on a surface of a print medium in a preview of the print medium.

### 2. Related Art

When an appearance of a three-dimensional object is previewed, in JP-A-2011-134100, rendering processing is executed by adding normal mapping, shadow mapping, and parallax mapping according to a height of a viewpoint. When the object is viewed from the front, the viewpoint is nearly perpendicular to an image plane. In this case, since it is difficult to recognize bumps on a surface of the object, processing is limited to normal mapping, and added mapping is not executed. On the other hand, when a direction of the line of sight is nearly parallel to the image plane, for example, when an object is viewed from an oblique direction, rendering is executed by sequentially adding normal mapping based on a bump map, horizon mapping based on a horizon map, and parallax mapping based on a height map. As described above, in JP-A-2011-134100, high-detailed and realistic mapping can be efficiently performed by progressively adding mapping according to a position of the viewpoint.

JP-A-2011-134100 is an example of the related art.

However, in JP-A-2011-134100, processing contents of a bump representation are merely determined depending on a direction and a height of the viewpoint relative to an object, that is, whether the object is viewed from the front or from an oblique direction, and the bump representation may not be sufficiently performed. For example, even when the object is viewed from the front, a bump is recognized when light is applied from an oblique direction, but such a case cannot be treated sufficiently. When previewing a bump on a surface of a print medium on which an image is formed by an image forming material such as ink, what kind of bump representation is to be selected and used was not discussed in the related art.

### SUMMARY

The present disclosure can be implemented in the aspects or application examples given below.

(1) The present disclosure can be implemented as an image display device. The image display device includes: an input unit configured to input image data of an image to be printed on a print medium; an acquisition unit configured to acquire a print condition for the print medium; a selection unit configured to select, from the acquired print condition, a method of a bump representation when the image data is processed; and a display execution unit configured to display a preview image of a printed material using the selected method of the bump representation.

(2) The present disclosure can also be implemented as an image print system. The image print system includes: an input unit configured to input image data of an image to be formed on a print medium using an image forming material; an acquisition unit configured to acquire a print condition that is a condition for printing on the print medium; a selection unit configured to select, from the acquired print condition, a method of a bump representation when the image data is processed; a display execution unit configured to display a preview image of a printed material using the selected method of the bump representation; and a print device configured to print the preview image on the print medium.

(3) The present disclosure can also be implemented as a non-transitory computer-readable storage medium storing an image processing program for generating a rendered image of a print medium on which an image is printed. The non-transitory computer-readable storage medium storing an image processing program causes a computer to execute: inputting image data of the image formed on the print medium using an image forming material; acquiring a print condition that is a condition for printing on the print medium; selecting, from the acquired print condition, a method of a bump representation when the image data is processed; and displaying a preview image of a printed material using the selected method of the bump representation.

### BRIEF DESCRIPTION OF THE DRAWINGS

FIG. 1 is a schematic configuration diagram showing an image processing device according to an embodiment.

FIG. 2 is a schematic configuration diagram showing a processing overview focusing on a configuration of a selection unit.

FIG. 3A is a diagram showing contents of a print condition database used for selecting processing of a bump representation to be applied.

FIG. 3B is a view showing a difference in bump representation methods.

FIG. 4 is a diagram showing an overview of tessellation processing according to the embodiment.

FIG. 5 is a diagram showing an overview of generation of a smoothness map according to the embodiment.

FIG. 6 is a flowchart showing an example of an image processing routine.

FIG. 7 is a schematic configuration diagram showing a rendering execution unit.

FIG. 8 is a view showing an example of a preview screen.

FIG. 9 is a diagram showing a relationship between a light source or a viewpoint and an angle of a surface of a 3D object or the like.

FIG. 10 is a view showing an appearance of ink printed on a print medium.

FIG. 11 is a view showing a difference in appearance depending on the number of vertices in displacement mapping.

FIG. 12 is a view showing triangular polygons and a method of increasing the number of vertices of the triangular polygons.

FIG. 13 is a view showing a comparison of appearances due to a difference in bump representations as an example of bumps formed of clear ink.

FIG. 14 is a diagram showing another configuration example of a rendering unit using displacement mapping including polygon division processing.

FIG. 15 is a schematic configuration diagram showing an image print system.

### DESCRIPTION OF EMBODIMENTS

### A. First Embodiment

### (A1) Overall Configuration of Image Processing Device 100

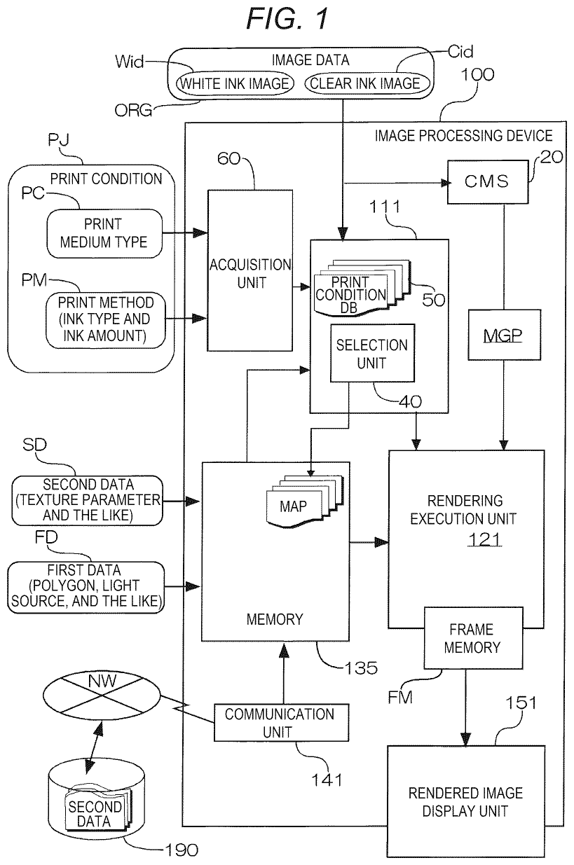

FIG. 1 shows an overall configuration of an image processing device 100 according to a first embodiment. The image processing device 100 executes image processing for previewing a state in which an image is printed at a predetermined print medium. As shown in the drawing, the image processing device 100 includes a color management system (hereinafter, simply referred to as a CMS) 20, an acquisition unit 60 that acquires a print condition PJ from the outside, a bump representation processing unit 111 that selects, from the acquired print condition, a method of a bump representation when image data is processed and generates a necessary map or the like, a rendering execution unit 121, a memory 135, a communication unit 141, and a rendered image display unit 151. The CMS 20 converts a color of an original image to be print previewed into a color of an object color represented on a print medium. Converted image data is referred to as managed image data MGP. Details of CMS processing will be described later. The bump representation processing unit 111 includes a print condition database 50 that stores relationships between various print conditions and a plurality of bump representations, and a selection unit 40 that selects a method of a bump representation. The print condition PJ input from the outside by the acquisition unit 60 includes a print medium type PC, a print method PM, and the like. The print method PM includes information related to a thickness of an ink layer, such as a type and an amount of ink which is one kind of image forming material. Details of the print condition PJ will be described later.

The image processing device 100 receives image data ORG from the outside, converts the image data ORG into the managed image data MGP using the CMS 20, and outputs the managed image data MGP to the rendering execution unit 121. The image processing device 100 not only executes image processing but also executes rendering using the rendering execution unit 121, and displays a processing result on the rendered image display unit 151 as a preview image. The rendering execution unit 121 and the rendered image display unit 151 correspond to a “display execution unit that displays a preview of a printed material using the selected method of the bump representation”. A program for executing processing to be described later is stored in the memory 135 or the like of the image processing device 100, and each function of the image processing device 100 is implemented by a CPU or a GPU executing a program stored in the memory.

In addition to such a program, the memory 135 stores first data FD, second data SD, and various maps such as a normal map used for a bump representation to be described later. The first data FD and the second data SD are parameters necessary for displaying a print medium on which an image is printed as a 3D object by physical-based rendering. In particular, the first data FD is data related to a form of a print medium under a light source in a virtual space, and includes 3D object information of the print medium, camera information CMR such as a position where the print medium is viewed, illumination information LGT such as a position and tint of illumination, and background information BGD indicating information on a background at which the print medium is placed. The second data SD is data related to image formation on a surface of the print medium, and includes, for example, texture data representing texture of the surface of the print medium. The first data FD and the second data SD are used when rendering is executed by the rendering execution unit 121.

Representative data having a predetermined use frequency or more of the first data FD and the second data SD may be stored in the memory 135 in a non-volatile manner in advance, selected as necessary, and referred to by the rendering execution unit 121. The texture data or the like when a print medium that is not generally used, for example, a print medium having a low use frequency is used, when a special material such as cloth, a can, or a plastic sheet is used, may be stored in an external site 190 and acquired via the communication unit 141 as necessary. The first data FD such as illumination information may be individually designated by a user at the time of rendering, but a representative camera angle and a light source may be stored in the memory 135 in advance and used. The camera angle is a position or a direction in which a user views a target print medium, and corresponds to a position of a virtual viewpoint and a direction of a line of sight of a user who views a virtual space. Therefore, a camera may be described as a “viewpoint” or a “view” as a direction of a viewpoint or a line of sight.

The image display unit 151 displays an image of a print medium rendered by the rendering execution unit 121 together with ink on a surface, a background, and the like. The image display unit 151 reads image data for display from a frame memory FM provided in the rendering execution unit 121 and displays the image data. The image display unit 151 may be provided in the image processing device 100 or may be provided separately from the image processing device 100. The image processing device 100 may be implemented as a dedicated device, or may be implemented by causing a computer to execute an application program. The computer also includes a terminal such as a tablet or a mobile phone. Since the processing of the rendering execution unit 121 requires considerable resources and calculation capability, only the rendering execution unit 121 may be implemented by a CPU or a dedicated GPU capable of high-speed processing, and the image processing device 100 may be implemented by providing the rendering execution unit 121 at a separate site on the network.

In the various maps stored in the memory 135, when a method of a bump representation for a print medium is selected according to the print condition PJ, an appearance of the print medium and an appearance of ink printed on a surface of the print medium are set. As will be described later, the maps include a normal map, a height map, a displacement map, a smoothness map, and the like. A map can be generated when the print condition PJ and the image data ORG are determined, and is stored in the memory 135 such that the map can be referred to from the rendering execution unit 121 at any time. A method for generating or using each map will be described later.

### (A2) Configuration and Function of Bump Representation Processing Unit 111

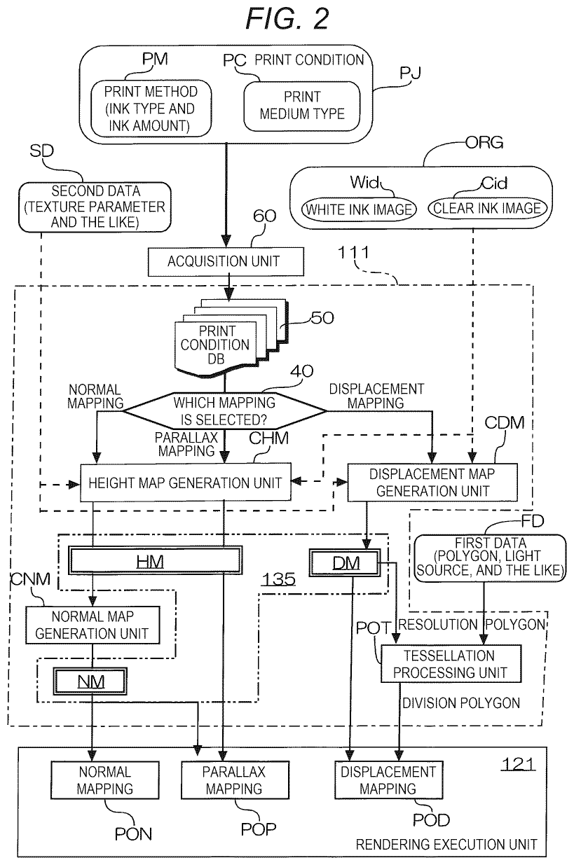

The bump representation processing unit 111 executes a bump representation for an image on a print medium. A detailed configuration of the bump representation processing unit 111 is shown in FIG. 2. Before describing functions of the print condition database 50 and the selection unit 40 constituting the bump representation processing unit 111, representative bump representation mapping used in rendering processing will be described.

[1] Bump mapping: a generic term for a technique of adding details of a bump to a 3D model. Alternatively, bump mapping may be a technique of applying a pseudo shadow to a bump. Actually, normal mapping described below is often used.

[2] Normal mapping: an RGB image (normal map) corresponding to XYZ values of a normal vector of a 3D model surface is generated. A load of rendering processing is relatively small.

Different from bump mapping, since vector data is used, a light intensity in a certain direction can be calculated in detail. The light intensity can be calculated from a height map to be described later.

[3] Parallax mapping: An illusion of three-dimensionality is created by shifting coordinates for acquiring texture according to a difference in height between a convex portion and a concave portion. A load of rendering processing is moderate. A height map is used to obtain parallax.

Even when normal mapping or parallax mapping is performed on a target such as a sphere, a contour of the sphere remains as the original sphere. Therefore, the above-described mapping in which a shape is not changed may be referred to as texture mapping.

[4] Displacement mapping: vertex coordinates of a polygon are shifted according to a height of a bump. A load of rendering processing is large. Different from any one of the above-described texture mapping, a contour of a model changes because the polygon is deformed. A height map is used when the displacement mapping is executed.

The above mapping is a typical bump representation method, and in general, a bump representation becomes fine and approaches an actual appearance in the above-described order, but a load required for processing increases. Note that some terms used in the above description and other maps and numerical values used in a bump representation may be added.

[5] Height map: an image representing a height of an object. In general, the height map functions as a grayscale image in which white indicates a high position. The height map can be used in the parallax mapping and the displacement mapping described above.

[6] Height scale: a numerical value representing a height.

The height map is a grayscale image represented by a value of 0 to 255 in the case of 8 bits, and does not store an absolute value of a height. It is possible to adjust to what extent effects of the parallax mapping and the displacement mapping are obtained by the height scale.

[7] Smoothness map: a numerical value representing smoothness.

The smoothness is represented by a value of 0.0 (coarse, gritty) to a value 1.0 (smooth, glossy). A portion on a print medium such as glossy paper where printing is performed with dye-based clear ink may have a value close to 1.0. On the other hand, in the case of not using clear ink, for example, when printing is performed on matte paper with pigment-based ink, a smoothness value may be close to 0.0.

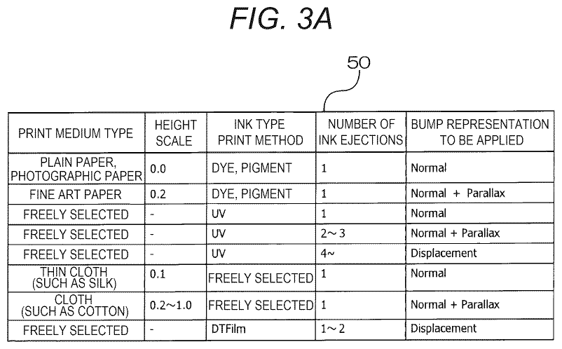

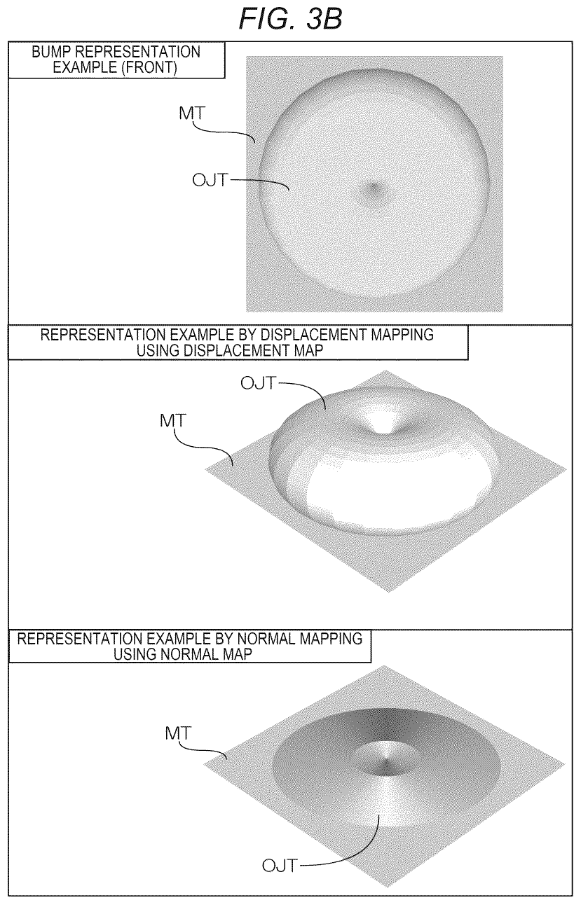

A configuration and an operation of the bump representation processing unit 111 will be described with reference to FIG. 2. First, the acquisition unit 60 acquires the print condition PJ from the outside. The print condition PJ includes a print medium type PC, a print method PM, and the like. The print medium type PC is information on a type of a print medium such as plain paper, photographic paper, fine art paper, thin cloth (for example, silk), and cloth (for example, cotton). The print method PM relates to a method of printing, and includes, for example, information related to a height of a bump of an ink layer, such as information indicating whether an ink type which is one kind of image forming materials is dye, pigment, UV curable ink, or the like, and information on the number of times of ink ejections. Other examples of the image forming material include DTFilm and a filament of a 3D printer. These pieces of information related to the image forming material correspond to an image forming material condition. The image forming material condition is classified according to a type of the image forming material and an amount of the image forming material. The image forming material is associated with a height of a bump on a print medium on which an image is formed. The classification of the image forming material condition will be further described later with reference to FIG. 3A.

A user of the image processing device 100 inputs the print condition PJ. As an input method, for example, a dialog box that selectably displays a plurality of types of print media, which is the print medium type PC, or a dialog box that selectably displays a plurality of types of ink or the number of times of printing, which is the print method PM, may be displayed to allow the user to select the print medium type PC and the print method PM. Alternatively, the print method PM may be collectively set by designating a model number of a print device.

When the print condition PJ is acquired, next, the print condition database 50 is referred to based on the print condition PJ. FIG. 3A shows an example of the print condition database 50 in a table format. Based on the print condition database 50, the selection unit 40 selects a method of a bump representation to be executed in the rendering execution unit 121 from the normal mapping, the parallax mapping, and the displacement mapping. For example, when the print medium type PC is plain paper and the print method PM is printing with one ejection of dye or pigment ink, the normal mapping is selected. Alternatively, when the print medium type PC is fine art paper and the print method PM is printing with one ejection of dye or pigment ink, the normal mapping and the parallax mapping are selected.

In the print condition database 50 shown in FIG. 3A, a method of a bump representation is selected according to a print medium type or a print method, for example, an ink type or the number of times of printing. The reason why the method of the bump representation is selected according to a specific print condition PJ is that, a depth of a bump on a surface of a print medium to be represented (a height difference between an upper surface of a convex portion and a bottom surface of a concave portion) is substantially determined by a type of the print medium, or a height of an ink layer rising on a surface of the print medium is substantially determined by the classification of a condition of an image forming material such as ink, that is, the classification of a type of ink which is one kind of image forming material, an ink amount, and the like. The ink amount which is an amount of ink is determined by the number of times of printing, ink duty in one printing, and the like. In the example shown in FIG. 3A, for example, the number of ink ejections is classified into one time, two and three times, and four times or more when UV ink is used. The classification is associated with a substantial height of a bump on a print medium on which an image is formed. Therefore, an appropriate bump representation at the time of preview can be selected by selecting a method of a bump representation based on the print medium type PC and the print method PM.

When a depth of a bump on a surface of a print medium or a thickness of an ink layer is less than a first threshold, the normal mapping is selected. A thickness comparison may be executed using measured values, and may be defined by a height scale, for example, the normal mapping may be executed when the thickness is less than 0.2, and the normal mapping and the parallax mapping may be executed when the thickness is 0.2 or more. In the case of actual dimension, when the ink layer has a thickness of about 0.1 mm to 0.2 mm, it is desirable to execute the parallax mapping together with the normal mapping. It is needless to say that the thickness of the ink layer is affected not only by an ink amount per unit area but also by a curing method, ink wettability, and the like when UV ink is used. Therefore, when the method of the bump representation is selected by the print condition PJ, it is desirable to calibrate a correspondence between the print condition PJ and the selected bump representation by measuring an actual thickness of the ink layer or the like. The number of thresholds for such determination is not limited to one, and a plurality of thresholds may be provided. For example, the displacement mapping may be selected when a depth of a bump on a surface of a print medium or a thickness of an ink layer is equal to or larger than a second threshold (1.0 or more in a height scale), which is larger than the first threshold.

In addition to these selection methods, for example, a method of a bump representation may be switched according to the number of times of printing with the UV ink. A thick and raised ink layer can be obtained by repeatedly performing printing with the UV ink at the same place. Therefore, a method of a bump representation is selected as follows according to the number of times of printing.

<1> The normal mapping is selected when the number of times of printing is one time.

<2> The normal mapping and the parallax mapping are selected when the number of times of printing is two times to three times.

<3> The displacement mapping is selected when the number of times of printing is four times or more.

Further, not only the number of times of printing but also an ink amount and print resolution may be added as conditions. For example, in a case where determinations of the above <1> to <3> are made under a condition that ink duty of one printing is 200% at the maximum, when the ink duty is 400%, the parallax mapping may be applied even when the number of times of printing is one time.

In FIG. 3A, the displacement mapping is selected regardless of the number of times of printing or the like when DTFilm is used. This is because, when DTFilm is used, since a print layer is bonded with an adhesive, a step is generated between a print medium and the print layer, and thus a step is generated in a contour of an image. When powder is attached, a thickness is increased by an amount of the powder and a step is generated.

When the normal mapping or the parallax mapping is selected, a height map generation unit CHM generates a height map HM using a texture parameter or the like which is the second data according to a white ink image Wid or a clear ink image Cid included in the image data ORG. Here, the white ink image Wid or the clear ink image Cid is given as an example of an image included in the image data ORG, but an ink color is freely selected. The clear ink image Cid is used when the clear ink image Cid is printed on another ink in an overlapping manner to enhance smoothness of a surface, and when a physical bump is provided on a print medium, such as Braille. In the drawings, a generated map is indicated by being surrounded by a double line.

A normal map generation unit CNM generates a normal map NM using the generated height map HM. A calculation formula for obtaining the normal map NM from the height map HM is well known. When the normal mapping is selected by the selection unit 40, the normal map NM is output to the rendering execution unit 121. The rendering execution unit 121 executes normal mapping PON using the normal map NM, renders an appearance of a surface of a print medium on which an image is printed with specific ink, and provides a preview. On the other hand, when the normal mapping and the parallax mapping are selected by the selection unit 40, the normal map NM and the height map HM obtained prior to the normal map NM are output to the rendering execution unit 121. The rendering execution unit 121 executes parallax mapping POP using the normal map NM and the height map HM, renders an appearance of a surface of a print medium on which an image is printed with specific ink, and provides a preview. Details of the rendering execution unit 121 will be described later.

When the displacement mapping is selected by the selection unit 40 based on the print condition PJ, a displacement map generation unit CDM generates a displacement map DM using the texture parameter or the like which is the second data according to the white ink image Wid or the clear ink image Cid included in the image data ORG. Different from the normal map NM and the height map HM described above, the displacement map DM is a map representing an actual three-dimensional shape.

In the mapping described above, the print medium to be previewed and the ink for forming an image are treated as a set of polygons, and the displacement map DM is different from maps of the normal mapping PON and the parallax mapping POP in that a three-dimensional representation is implemented by displacing vertices of polygons constituting a surface of an object. In the normal mapping PON and the parallax mapping POP, a three-dimensional representation is implemented by a preview, and a three-dimensional effect is not achieved by changing a shape of a polygon. This point will be described with reference to FIG. 3B. An upper part in the drawing shows an example of a bump representation when a preview is displayed. In this example, an object OJT disposed on a print medium MT has a hemispherical shape in which a bowl is inverted and a center of the object OJT is recessed. The object OJT is formed of, for example, clear ink. An appearance of the object OJT when viewed from directly above is only different in a level of a bump representation in the normal mapping using the normal map NM, the parallax mapping using the normal map NM and the height map HM, and the displacement mapping using the displacement map DM.

On the other hand, when viewed from an oblique direction in front of the object OJT, in the displacement mapping using the displacement map DM shown in a middle part of the drawing, a contour of the object OJT is actually displaced, so that the three-dimensional object OJT is represented by a bump representation, and a part hidden by the object OJT when viewed from the viewpoint occurs. Since a light source is located in front of the object OJT, a shadow of the object is not shown in the drawing, but the shadow of the object is also displayed in the displacement mapping. On the other hand, for example, in the normal mapping using the normal map NM, since the shape is not changed although the shadow is added, it can be seen that the object OJT is viewed as a simple plane to which the shadow is added, as shown in a lower part of the drawing.

In the displacement mapping, which is a bump representation using the displacement map DM, vertices of a polygon are displaced according to bumps caused by a print medium and ink. Such processing of displacing vertices of a polygon may deteriorate reproducibility of an original bump shape. This is because when a polygon is relatively large, a position where a thickness of an ink layer actually changes and a position of a movable vertex of the polygon may not coincide with each other. Therefore, a polygon to be displaced is divided, a size of one polygon is reduced, and the number of movable vertices is increased, thereby executing processing for ensuring shape reproducibility. This processing is called tessellation processing POT. As shown in the overview in FIG. 2, a division level of the polygon is obtained based on resolution of the displacement map DM and information on the polygon included in the first data used for representing an original image, and the division level is output to the displacement mapping POD together with the displacement map DM. Accordingly, reproducibility of an original bump shape by the displacement mapping POD can be ensured.

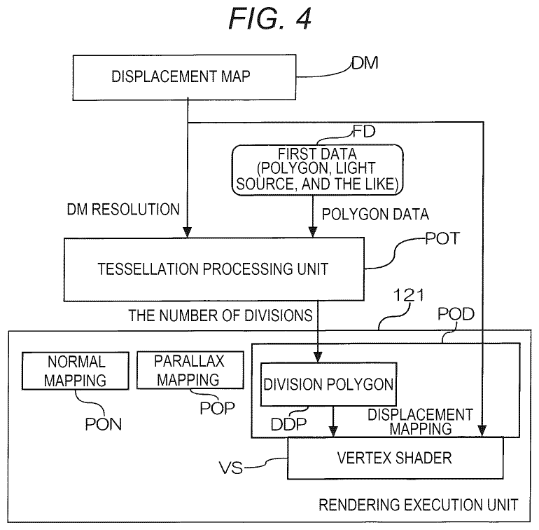

Details of the tessellation processing POT are shown in FIG. 4. As shown in the drawing, in the tessellation processing POT, based on basic polygon data included in the first data FD, a polygon is divided according to the resolution of the displacement map DM, data of vertices of each division polygon is calculated, and the data is stored as a division polygon DDP. Information on vertices of the division polygon DDP and the displacement map DM are used for the displacement mapping POD in the rendering execution unit 121 to achieve movement of the vertices of a division polygon in a vertex shader VS and achieve a bump representation of a print medium and printed ink. The number of division polygons DDP may be determined in consideration of reproducibility of an original shape and a processing load of a vertex shader VS. For example, the basic number of divisions may be set to SDD (for example, a value of 20), and may be determined based on resolution Gdm of the displacement map DM and display resolution Gds of the image display unit 151 according to the following Formula (1).

$$DDP = SDD \times Gdm / Gds \qquad ( 1 )$$

When the resolution Gdm of the displacement map DM is 360 dpi, resolution of a display device such as the image display unit 151 is generally about 72 dpi, and thus

$$DDP = 20 \times 360 / 72 = 100$$

It is needless to say that a user may adjust the basic number of divisions SDD to a desired division number DDP by viewing preview image displayed on the image display unit 151. Alternatively, the number of divisions may be determined according to a distance between a viewpoint to be described later and an object to be previewed. Since shapes of the print medium and the printed ink are previewed in detail by increasing the number of divisions as a distance to the viewpoint decreases, it is desirable to increase the number of divisions to improve reproducibility of the shapes.

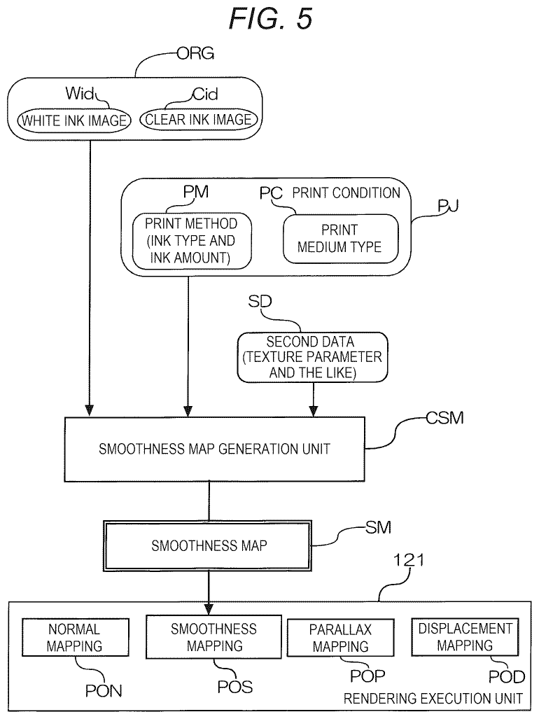

From the viewpoint of shape reproducibility, smoothness of a surface of an object may also be important. As described above, the smoothness map is used to reproduce surface smoothness. How to handle the smoothness map is shown in FIG. 5. The smoothness map SM is generated by a smoothness map generation unit CSM provided in the bump representation processing unit 111. The smoothness map generation unit CSM mainly receives data of the clear ink image Cid from the image data ORG, and generates the smoothness map SM using the received data and the second data SD including the print condition PJ, a texture parameter, and the like. The smoothness map SM is used for smoothness mapping POS in the rendering execution unit 121.

Although the normal mapping PON, the parallax mapping POP, and the displacement mapping POD described above are shown side by side in the rendering execution unit 121 in the drawings, since the mapping is selected by the selection unit 40, in practice, only the mapping selected based on the print condition PJ is executed in the rendering execution unit 121, and a bump representation for a print medium MT and printed ink is performed. In FIG. 2, the selection unit 40 selects a method of a bump representation based on the print condition PJ, and generates a necessary map in response to the selection, but all maps to be used by the rendering execution unit 121 may be generated after the acquisition unit 60 acquires the print condition PJ or the like, and the rendering execution unit 121 may use a necessary map (the normal map NM, the height map HM, the displacement map DM, or the like) according to the method of the bump representation (the normal mapping, the parallax mapping, the displacement mapping, or the like) selected by the selection unit 40.

### (A3) Overview of Processing in Image Processing Device 100

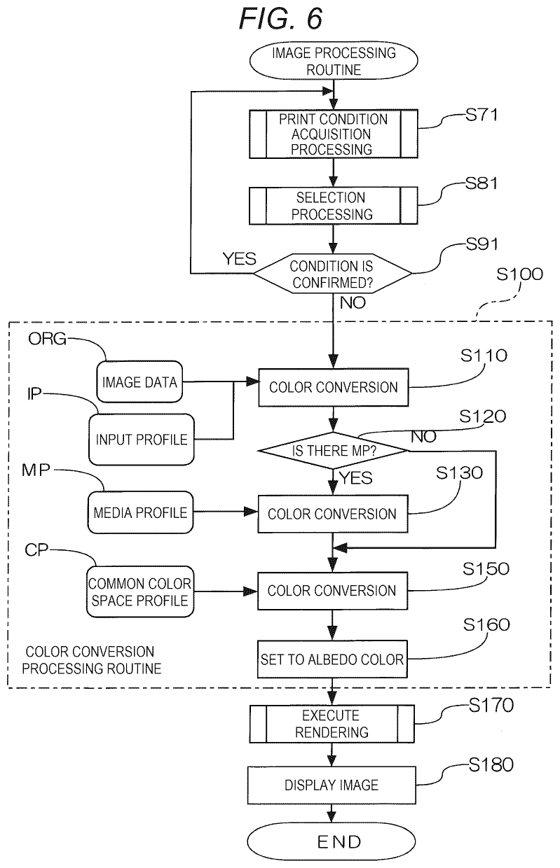

In addition to the function of the bump representation processing unit 111 described above, the image processing device 100 executes an image processing routine shown in FIG. 6 for preview. When the processing is started, the image processing device 100 first executes print condition acquisition processing (step S71). This processing is executed by the acquisition unit 60 described above. Here, the image data ORG to be printed is also acquired in response to the acquisition of the print condition. The image processing device 100 displays a necessary dialog box and the like by the acquisition unit 60, and inputs the print conditions PJ and the image data ORG.

Subsequently, the image processing device 100 executes selection processing of selecting a method of a bump representation (step S81). This processing is executed by the selection unit 40 described above. As a result of the processing executed by the selection unit 40, in the present embodiment, a method of a bump representation for a print medium and printed ink is selected from the normal mapping, the parallax mapping, and the displacement mapping. The method of the bump representation is not limited to being selected from the above described three methods. When the image processing device 100 can execute only two of the three methods, the image processing device 100 may select a method from the two methods or may select a method from four or more methods including other methods. By the above processing (steps S71 and S81), it is determined whether a preview condition is confirmed (step S91), and the above processing is repeated until the preview condition is confirmed, and when the preview condition is confirmed, the processing proceeds to a color conversion processing routine of step S100.

The color conversion processing (step S100) is processing executed by the CMS 20 of the image processing device 100. This processing is processing for the CMS 20 to convert original image data ORG into color data of a common color space for executing rendering processing. Step S100 includes the following processing (steps S110 to S160). When the color conversion processing is started, first, the original image data ORG and an input profile IP are input, and the original image data ORG represented by a device-dependent color system (for example, an RGB color system) is converted into color data of a device-independent color system (for example, Lab or XYZ color system) (step S110). Next, it is determined whether a media profile MP is prepared (step S120), and when there is a media profile MP, the media profile MP is applied, and color conversion into a range of colors that can be represented by printing is performed in consideration of a combination of a print device (printer)×a print medium serving as a print condition (step S130). When there is no media profile MP, the processing of step S130 is not performed. Thereafter, a common color space profile CP is used to perform conversion into a color value of a common color space which is a second color space used in rendering (step S150). In the present embodiment, sRGB is used as the common color space. The managed image data MGP obtained in this manner is set to an albedo color which is texture of a 3D object (step S160), and the color conversion processing (step S100) is ended.

Roles and functions of the profiles used in the above-described processing will be supplemented. The input profile IP is used to convert a device-dependent input color system such as RGB data into a device-independent color system such as L*a*b* (hereinafter, simply referred to as Lab). The media profile MP is a profile representing color reproducibility when printing is performed on a specific print medium by a specific print device such as a printer under a print condition such as specific printing resolution, and is a profile for converting a color value between a device-independent color system and a device-dependent color system. The media profile MP includes information such as a print setting of a print device in addition to a print medium. Therefore, when all combinations of a print device (printer)×a print medium×a print setting are covered, types of the media profiles MP increase, and thus, when dependency of a print condition is small or when the number of profiles is not desired to be increased, the media profile MP is configured as a combination of a print device (printer)×a print medium. Further, the same media profile MP may be applied to a group of a plurality of print media having similar color development features. In this case, it is desirable to use the common media profile MP by grouping print media having not only similar color development features but also the same or similar duty limits according to an ink reception amount on a print medium side. As described above, since a color of an image on a print medium is related to features of a print device and features of a print medium, the media profile MP may be hereinafter referred to as a print profile MP.

When the input profile IP is applied to the image data ORG and further the print profile MP is applied, a color value in a case where printing is performed under a specific print condition, that is, a color value depending on a print device or a print medium is obtained. When the print profile MP is applied such that a color value of an image is converted from a device-dependent color system to a device-independent color system and further the common color space profile CP is applied, the color value is converted into a representation in a second color space (here, an sRGB color space) used for rendering. Since the print profile MP is used to perform conversion into a color value depending on features of a print device, a print medium, and the like, the image data ORG is color-converted into a color in a range of color values that can be actually printed. The common color space profile CP is used to convert image data into a color value in a color space used for rendering. An sRGB color space is representative as a common color space, and Adobe RGB, Display-P3, or the like may be used.

As described above, the CMS 20 uses each profile to convert the image data ORG represented in a first color space which is a device-dependent color system into the image data (managed image data) MGP represented in the sRGB color space which is a second color space used for rendering. Here, the converted image data is not limited to a color value in the sRGB color space, and may be represented in any color space as long as the image data is represented in a color space that can be handled by the rendering execution unit 121. For example, when the rendering execution unit 121 adopts a configuration capable of performing rendering using a color value in a Lab or XYZ color space, the image data may be converted into a color value used for display on the image display unit 151 in lighting processing (which will be described later) executed in the rendering execution unit 121 or in a post-processing unit (which will be described later) placed in a subsequent stage of the rendering execution unit 121.

In step S130, when a rendering intent of a color conversion of a media profile is set to be absolute, a color (ground color) of a print medium can be reflected. When a color value of an image to be subjected to the color conversion in step S150 is outside a color gamut of the sRGB color space, the color value may be approximated to a value within the sRGB color space, or may be treated as a value outside the sRGB color gamut. An RGB value of image data is generally stored in 8 bits for each color, that is, an integer of 0 to 255, but the disclosure is not limited thereto, and a method capable of designating a wider color range may be used. For example, when a signed integer (signed bit) is adopted or the number of bits representing RGB values is increased, even a negative value or a value exceeding 255, that is, a value outside the sRGB color gamut can be easily handled. When a pixel value is expressed as a floating point of values 0.0 to 1.0, a value outside the sRGB color gamut may be treated as a negative value or a value exceeding 1.0.

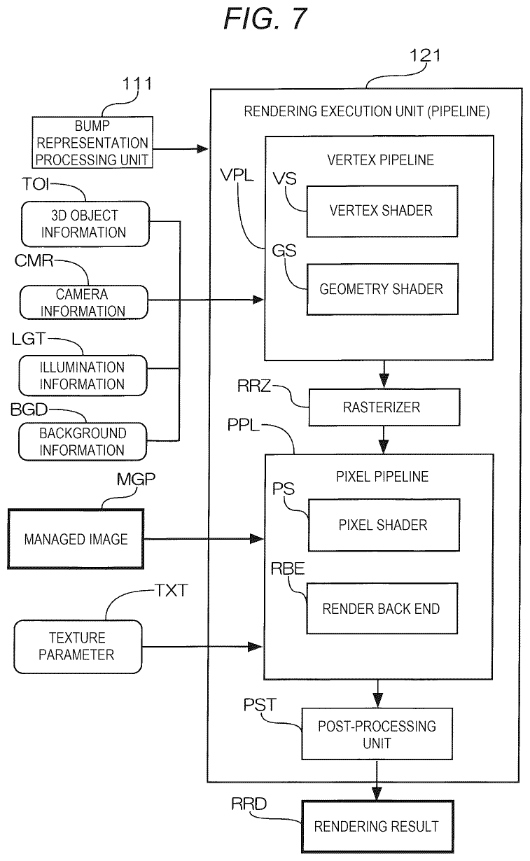

The color conversion performed by the CMS 20 is not limited to the configuration shown in the drawing, and other methods can be used. For example, color conversion processing using display device correction data DPD may be executed after the color conversion using the media profile MP (step S130). Alternatively, synthesized correction data SPD obtained by synthesizing the display device correction data DPD and the common color space profile CP in advance may be prepared, and a color conversion using the synthesized correction data SPD may be performed instead of the color conversion using the common color space profile CP (step S150). Alternatively, a device link profile obtained by synthesizing the input profile IP and the media profile MP may be prepared, and the device link profile may be applied to perform a conversion instead of individually applying the input profile IP and the media profile MP. A correction for a deviation of a display color of the image display unit 151 may be performed in the post-processing unit PST after a render back end shown in FIG. 7 to be described later, instead of being performed in the CMS 20.

### (A4) Rendering Processing

After the above-described color conversion processing (step S100), rendering processing (step S170) is executed, and a processing result is displayed on the image display unit 151 as a preview image. The rendering processing is executed by the rendering execution unit 121. The rendering execution unit 121 displays, on the image display unit 151, an appearance of the print medium MT on which the original image data ORG is printed and an appearance of ink printed on a surface of the print medium MT in a virtual space by arranging and rendering the ink based on the managed image data MGP color-converted and output by the CMS 20 on each print medium MT. FIG. 7 shows a configuration example of the rendering execution unit 121. FIG. 7 shows a typical configuration of the rendering execution unit 121 for executing physical-based rendering processing, and other configurations may be adopted. The rendering execution unit 121 according to the present embodiment adopts a pipeline configuration including a vertex pipeline VPL and a pixel pipeline PPL, and executes physical-based rendering at high speed. The vertex pipeline VPL includes a vertex shader VS and a geometry shader GS. Note that a configuration without using the geometry shader GS can be adopted.

The vertex shader VS converts coordinates on a print medium of vertices of the print medium MT, which is a 3D object, into coordinates in a three-dimensional space to be rendered. The coordinate conversion comprehensively includes coordinate conversion such as coordinates of a model (here, a print medium) to be rendered-world coordinates-view (camera) coordinates-clip coordinates, and a conversion into view coordinates or the like is performed by the geometry shader GS. In addition, the vertex shader VS also executes horizon mapping, calculation of texture coordinates (UV), and the like. Further, as described with reference to FIG. 4, the vertex shader VS refers to the displacement map DM and moves vertices of a division polygon obtained by dividing a polygon by the tessellation processing POT. In these kinds of processing, the vertex shader VS and the geometry shader GS refer to print medium data TOI, camera information CMR, illumination information LGT, background information BGD, and the like.

The print medium data TOI is information related to a shape and the like of a print medium serving as a 3D object. A print medium and printed ink handled in the present embodiment have a three-dimensional shape, and surfaces of the print medium or the printed ink are not a flat surface. Therefore, the print medium MT and the ink are treated as a three-dimensional shape having minute bumps on surfaces of the print medium MT and the ink. Basically, the bumps are treated as a set of minute polygons. When a surface of a print medium or the like is represented by minute polygons, the number of polygons is enormous. Therefore, in order to represent bump shapes on the surface, it is selected to treat the surface of the print medium according to texture such as the normal map NM or the height map HM described above. The textures such as the normal map NM and the height map HM are given as a texture parameter. The camera information CMR is virtual information indicating a position and a direction in which a camera is installed relative to a print medium. The illumination information LGT includes at least one piece of virtual information such as a position, an angle, an intensity, and a color temperature of a light source in a virtual space where a print medium is placed. Note that a plurality of light sources can be set, and in this case, influences of the plurality of light sources may be separately calculated and superimposed on a 3D object.

Although the background information BGD may be omitted, the background information BGD is information related to a background at which a print medium serving as a 3D object is placed in a virtual space. The background information BGD includes information on objects such as a wall and a table arranged in a virtual space, and these objects are to be rendered by the rendering execution unit 121 in the same manner as a print medium. Since illumination is applied onto background objects and illuminates the print medium, the illumination is also treated as a part of illumination information. A three-dimensional preview can be performed by performing rendering using such various types of information. Vertex information calculated by the vertex shader VS is delivered to the geometry shader GS.

The geometry shader GS is used to process a set of vertices of an object. The geometry shader GS can increase or reduce the number of vertices at the time of execution, and can change a type of primitives constituting a 3D object. An example of increasing or reducing the number of vertices is culling processing. In the culling processing, a vertex that is not reflected in a camera is excluded from a processing target based on a position and a direction of the camera. The geometry shader GS also executes processing of generating a new primitive from existing primitives such as points, lines, and triangles. The geometry shader GS inputs a primitive having information of all primitives or an adjacent primitive from the vertex shader VS. The geometry shader GS processes the input primitive and outputs a primitive to be rasterized.

An output of the vertex pipeline VPL, specifically, the primitive processed by the geometry shader GS, is rasterized by a rasterizer RRZ, converted into data in units of pixels, and delivered to the pixel pipeline PPL. In the present embodiment, the pixel pipeline PPL includes a pixel shader PS and a render back end RBE.

The pixel shader PS operates rasterized pixels, and in short, calculates a color for each pixel. Based on information input from the vertex shader VS or the geometry shader GS, the pixel shader PS executes processing of synthesizing texture or processing of applying a surface color. The pixel shader PS maps, on a print medium serving as a 3D object, the managed image data MGP obtained by converting the image data ORG by the CMS 20 based on various profiles. At this time, a lighting processing function provided in the pixel shader PS executes the lighting processing based on a reflection model of light of an object, the illumination information LGT described above, and a texture parameter TXT which is one piece of the second data SD stored in a second storage unit 132, and maps the managed image data MGP. The texture parameter TXT is also designated for a surface of the print medium MT, and is important for a portion where an image ORG is printed on the print medium MT. When printing on the print medium MT is performed by a transfer method, a parameter representing texture in a state where ink printed on transfer paper is transferred to a surface of the print medium MT is used. In a case where printing is performed by directly ejecting UV ink onto the print medium MT, a parameter representing texture after the ink is cured by ultraviolet rays is used. The reflection model used in the lighting processing is one of calculation formulas of a mathematical model for simulating an illumination phenomenon in the real world. The reflection model used in the present embodiment will be described in detail later.

When the number of pixels after rasterization increases, for example, when output resolution is high, a load of processing for operating pixels becomes high, and the processing takes time. Therefore, the processing takes time, and efficiency of pipeline processing may be insufficient, as compared with the processing in units of vertices. In the present embodiment, a processing program of the pixel shader PS is optimized for execution by a GPU having high parallel processing performance, thereby achieving a high-level effect including texture representation in a short time.

The render back end RBE further determines whether pixel information obtained by the processing of the pixel shader PS is to be written in a frame memory FM for display. After the render back end RBE determines that there is no problem in drawing pixel data in the frame memory FM, the pixel data is stored as data to be drawn. Examples of a test used to determine the drawing include a known “alpha test”, “depth test”, and “stencil test”. Among these tests, the render back end RBE executes a set test, and writes the pixel data into the frame memory FM.

The pipeline processing of rendering is ended by the above processing, and then the post-processing unit PST executes processing for improving an appearance on the data stored in the frame memory FM. Such processing includes, for example, anti-aliasing processing for removing unnecessary edges of an image to smooth the image. In addition, there is processing such as ambient occlusion, screen space reflection, and depth of field, and the post-processing unit PST may be configured to execute necessary post processing.

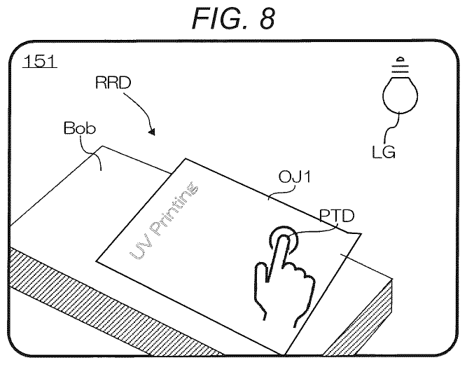

By the rendering execution unit 121 executing the above processing, the rendering ends, and a result is output as a rendering result RRD. Actually, the data written in the frame memory FM is read out according to a display cycle of the image display unit 151, and is displayed as the rendering result RRD (FIG. 6, step S160). An example of the rendering result RRD is shown in FIG. 8. In this example, a medium OJ1 printed with ink, a light source LG, and a background object Bob such as a part of a table existing as one background are displayed on the image display unit 151 as 3D objects placed in a virtual space.

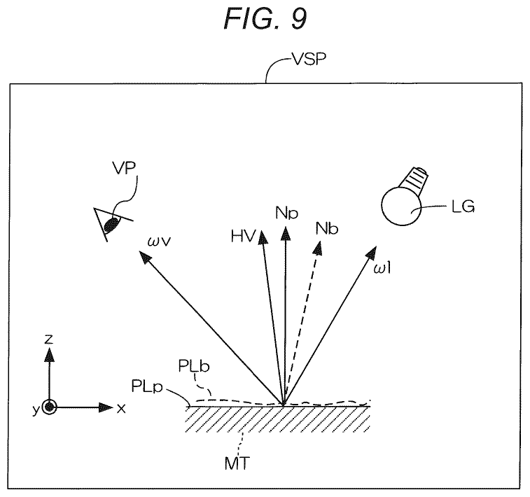

FIG. 9 shows an example of a relationship between the print medium MT and the light source LG or a viewpoint (camera) VP that are placed in a virtual space. The relationship between the light source LG or the viewpoint VP and the print medium MT is three-dimensional in a virtual space VSP, but the virtual space VSP is indicated by an x-z plane in the drawing. x is a coordinate of a point at which vectors to be described below are collected. A positional relationship between the viewpoint VP and the light source LG that illuminate a predetermined coordinate x of the print medium MT on which an image ORG to be rendered is printed will be exemplified. FIG. 9 shows a light source direction vector ωl from the coordinate x toward the light source LG, a viewpoint direction vector ωv from the coordinate x toward the viewpoint VP, and a half vector HV between the light source direction vector ωl and the viewpoint direction vector ωv. A reference sign Np indicates a normal vector when it is assumed that a surface of the print medium MT is an imaginary plane PLp when viewed microscopically, and a reference sign Nb indicates a normal vector at the coordinate x of an actual plane PLb of the actual print medium MT which is not a plane when viewed microscopically.

In the image processing device 100 according to the present embodiment, it is possible to freely change a position and an angle of the print medium in the virtual space and confirm an appearance of an image on the print medium. As shown in FIG. 8, this can be implemented by a series of processing in which the rendering execution unit 121 executes rendering processing on the image displayed on the image display unit 151 each time a position or angle of the print medium MT having a three-dimensional shape is changed according to an instruction by operating a pointing device and dragging an object with a pointer PTD displayed on a screen by the pointing device, and a processing result is displayed on the image display unit 151. Here, the pointing device may be a 3D mouse, a tracking ball, or the like, or may be of a type in which a multi-touch panel provided in the image display unit 151 is operated with a finger or a touch pen. For example, when a multi-touch panel is provided on a surface of the image display unit 151, the print medium MT or the light source LG may be directly moved by a finger or the like, the print medium MT may be rotated using two fingers, or a distance between the light source LG and the actual plane PLb of the print medium may be three-dimensionally changed.

When a position, an angle, or the like of the print medium MT or the light source LG in the virtual space is changed, the rendering execution unit 121 executes the rendering processing each time of such a change, and displays a rendering result RRD on the image display unit 151. When a position, an angle, or the like of the print medium MT or the light source LG in the virtual space is changed, the print medium on which the image is printed is subjected to physical-based rendering each time of such a change, and an actual print medium on which an image is printed is shown in a state close to a state of being viewed in a real space.

In particular, in the present embodiment, in addition to converting a color of an image to be printed on a print medium into a color of an image to be actually printed by the color management system (CMS), in the lighting processing at the time of rendering,
[1] the print medium on which the image is printed and ink to be printed are treated as 3D objects, and
[2] texture of a surface of the print medium or texture of the ink printed on the surface is considered using the texture parameter TXT,
so that reproducibility of the print medium displayed on the image display unit 151 is fairly high. Hereinafter, the processing of [1] and [2] will be described.

### Processing [1]

An appearance of the 3D object in the virtual space can be represented using luminance and a bidirectional reflectance distribution function (BRDF) of reflected light at each portion of the object. The bidirectional reflectance distribution function BRDF indicates an angle distribution feature of reflected light when light is incident from a specific angle. The luminance is brightness of the object. Both are collectively referred to as an illumination model. An example of the reflection model adopted in the present embodiment is shown as follows. BRDF can be expressed as a function f(x, ωl, ωv), and the luminance can be expressed as a function L(x, ωv) as in the following formulas (2) and (3).

$$f ( x , ω l , ω v ) = kD / π + kS * ( F * D * V ) \qquad ( 2 )$$

$$L ( x , ω v ) = f ( x , ω l , ω v ) * E ⊥ ( x ) * n \cdot ω l \qquad ( 3 )$$

x indicates an in-plane coordinate, ωv indicates a viewpoint direction vector, and ωl indicates a light source direction vector.

kD indicates a diffuse albedo, kS indicates a specular albedo, F indicates a Fresnel term, D indicates a normal distribution function, and V indicates a geometric attenuation term.

E⊥(x) indicates illuminance perpendicularly incident on the coordinate x and n indicates a normal vector.

A first term kD/n of the BRDF is a diffuse reflection component and is a Lambert model. A second term is a specular reflection component and is a Cook-Torrance model. In the formula (2), kD/n may be referred to as a diffuse reflection term, and kS*(F*D*V) may be referred to as a specular reflection term. The Fresnel term F, the normal distribution function D, and the geometric attenuation term V are not described because a model and a calculation method thereof are known. The BRDF may be a function corresponding to a reflection feature of a surface of a 3D object or a purpose of rendering. For example, a Disney Principled BRDF may be used. In the present embodiment, the BRDF is used as a function representing light reflection, but a bidirectional scattering surface reflectance distribution function (BSSRDF) may be used as a function representing light reflection.

As can be seen from the above formulas (2) and (3), the normal vector n, the light source direction vector ωl, and the viewpoint direction vector ωv are required to calculate the reflection model. The print medium is treated as a 3D object configured with a plurality of minute polygons to be subject to the rendering processing, and the normal vector n that reflects minute bumps on a surface of the print medium is calculated based on a normal Np of a polygon and a normal map to be described later. Therefore, in the vertex pipeline VPL, the normal Np of a polygon and UV coordinates for determining a reference position of the normal map are calculated, and are input to the pixel pipeline PPL together with the light source direction vector ωl and the viewpoint direction vector ωv. In the pixel pipeline PPL, the pixel shader PS refers to the normal map given as one texture parameter using the UV coordinates, and calculates the normal vector n based on a value of the referred normal map and the normal Np of a polygon.

In the present embodiment, as described above, the print medium MT on which the image ORG is printed is treated as a 3D object, and the physical-based rendering is executed according to the above formulas (2) and (3). As shown in FIG. 9, the light source direction vector ωl and the viewpoint direction vector ωv are calculated each time a user changes a position, an angle, or the like of the actual plane PLb of the print medium or the light source LG in the virtual space using a pointing device.

### Processing [2]

In the present embodiment, texture of a surface of a print medium and texture of printed ink are considered using the texture parameter TXT. The texture parameter TXT includes the following parameters, but it is not necessary to consider all of the parameters, and at least one of the following parameters, for example, smoothness, may be considered.

### Smoothness(S) or Roughness (R)

The smoothness(S) is a parameter indicating smoothness of a surface of a 3D object. The smoothness S is generally specified in a range of values of 0.0 to 1.0. The smoothness S affects the normal distribution function D and the geometric attenuation term V of the BRDF in the above formula (2). When a value of the smoothness is large, specular reflection becomes strong, and glossiness is exhibited. Instead of the smoothness S, the roughness R may be used. The smoothness S and the roughness R can be converted as S=1.0−R. The smoothness may be referred to as a smoothness value, and the roughness may be referred to as a roughness value.

### Metallic M

The Metallic M indicates a level to which a surface of a 3D object exhibits a metallic property. When the metallic property of the surface is high, a value of the metallic M is large. When the metallic M is large, a surface of an object is likely to reflect light from the surroundings, and is likely to reflect a surrounding scenery to hide a color of the object. The metallic M affects the Fresnel term F.

The Fresnel term F can be expressed by the following formula (4) using the Schlick approximation.

$$F ( ω l , h ) = {F}_{0} + ( 1 - {F}_{0} ) {( 1 - ω l \cdot h )}^{5} \qquad ( 4 )$$

Here, h indicates a half vector between the viewpoint direction vector ωv and the light source direction vector ωl, and F₀ is a specular reflectance at the time of perpendicular incidence. The specular reflectance F₀ may be directly designated as a color of specular reflection light (specular color) or may be given according to a formula (5) of linear interpolation (here, referred to as a lerp function) using the metallic M.

$${F}_{0} = lerp ( 0.04 , tC , M ) \qquad ( 5 )$$

Here, tC indicates a color (albedo color) of texture of a 3D object. Note that the value 0.04 in the formula (5) representatively indicates each value of the RGB indicating a general value in a non-metal. The same applies to the color tC of texture. Although the term “metallic” is used here, a material having a high reflectance and a glossy appearance, such as a surface of ceramic, is treated as a material having a high metallic property M even if the material is not metal.

### Normal Map

In a normal map, a normal vector of a minute uneven surface of a surface of a print medium is represented. By associating (pasting) a normal map with a 3D object, a normal vector of a minute uneven surface of a surface of a print medium can be assigned to the 3D object. The normal map may affect the Fresnel term F, the normal distribution function D, and the geometric attenuation term V of the BRDF.

### Other Texture Parameters

In addition, a parameter that can function as a texture parameter includes a specular color, a clear coat layer parameter indicating the presence or absence of a clear coat layer on a surface of a print medium, a thickness of a clear coat layer, transparency, or the like.

As described above,
[1] a print medium on which an image is printed is treated as a 3D object, and
[2] texture of a surface of the print medium or texture of a surface of printed ink is considered using the texture parameter TXT,
thereby enabling the image processing device 100 according to the present embodiment to display an appearance of the print medium MT on which the image ORG is printed on the image display unit 151 with a high degree of freedom and high reproducibility.

### (A5) Functions and Effects of First Embodiment

According to the image processing device 100 in the first embodiment described above, the image data ORG of an image to be printed on the print medium MT is acquired, and an appearance when printing is performed on the print medium MT with ink is rendered using a method of a bump representation selected based on the print condition PJ. Therefore, when printing is performed once on plain paper with dye or pigment, since bumps on a surface of the print medium MT, bumps caused by printing with ink, and the like are not so large, rendering is executed by the normal mapping. Accordingly, a processing load can be reduced. Bumps on a paper surface, bumps caused by ink, and the like can be sufficiently represented. On the other hand, when printing is performed on fine art paper with dye or pigment, or when ink is ejected two to three times for UV ink and UV curing is performed, rendering is executed by executing the normal mapping using the normal map NM and the parallax mapping using the height map HM. This is because ink may significantly rise, for example, by about 0.2 mm from a surface of the print medium MT in such printing.

On the other hand, when printing is performed four times or more with UV ink and UV curing is performed, or when printing is performed using the DTFilm, since a thickness of ink is further increased, rendering is executed by adopting the displacement mapping POD using the displacement map DM. In this manner, a load of rendering increases, but a bump shape of the surface of the print medium MT including the thickness of the ink is clearly represented. As described above, since a method of representing the bump shape is switched according to the print condition PJ (see FIG. 3A), it is possible to achieve both a processing load and reproducibility of a preview.

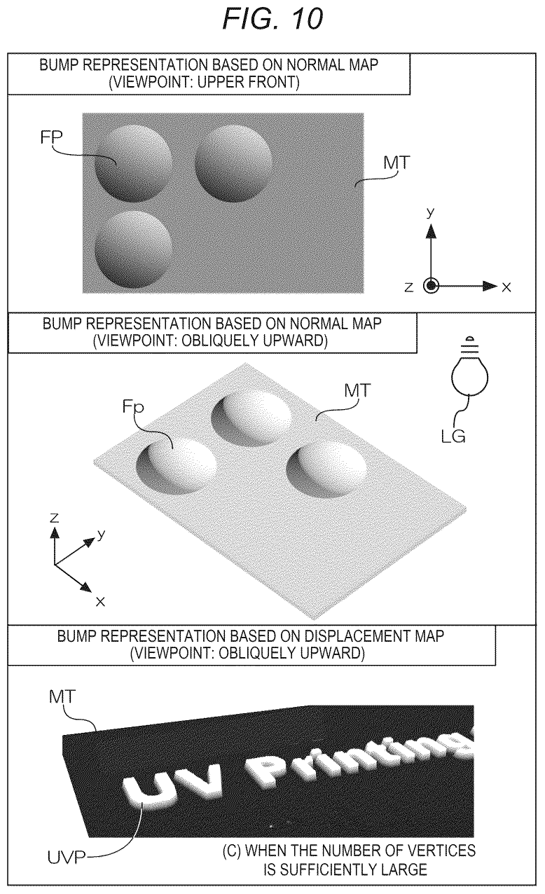

FIG. 10 shows an example of appearances of the print medium MT and ink printed on the print medium MT. An upper part of the drawing shows an example of bump representation using the normal map NM. In this example, the viewpoint is on a front upper side (Z direction) of the print medium MT, and a light source LG is on a Z direction and a Y direction, that is, on an obliquely upper side. Bumps FP corresponding to Braille formed by clear ink are formed on a surface of the print medium MT. A middle part of the drawing shows a bump representation of the same target when the viewpoint is on an obliquely upward side. In both of the upper part and the middle part of the drawing, rendering is executed by the normal mapping PON using the normal map NM, and bumps are represented by shading. Although the rendering using the normal mapping PON will be described later in comparison with a result of rendering by the displacement mapping POD using the displacement map DM, since bumps are represented by shading, as described with reference to FIG. 3B, depending on the way of viewing, a flat surface may be simply printed or a concave portion may be represented instead of a bump.

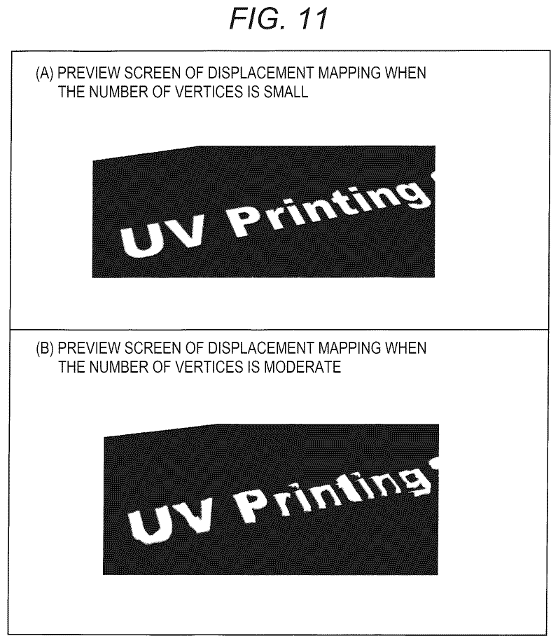

A bottom part of FIG. 10 shows an example of a result of rendering by the displacement mapping POD using the displacement map DM. Here, a character string UVP of “UV Printing” is formed at the black print medium MT by four times of printing with white UV ink. In this example, the displacement mapping using the displacement map DM is adopted, and as shown in FIG. 4, tessellation processing POT is performed to divide polygons serving as an ink shape. The tessellation processing POT was described above, and the division of the polygons affects a result of rendering processing executed in a subsequent stage. This point will be described with reference to FIG. 11.

An upper part of FIG. 11 shows an appearance when the same character string UVP is composed of a small number of polygons and rendered by the displacement mapping POD. Since the number of polygons is small and the number of vertices that can be displaced is small, the character string UVP looks flat, and a thickness bump representation by ink is weak. In general, in a case where the print medium MT is paper having smoothness equal to or higher than that of plain paper, for example, photographic paper, when a surface of the print medium MT is composed of polygons, a polygon having a size similar to resolution of the image display unit 151 is sufficient. This is because the number of bumps on a surface of printing paper or the like is small. This is not applied to a case where the print medium MT is fabric or the like.

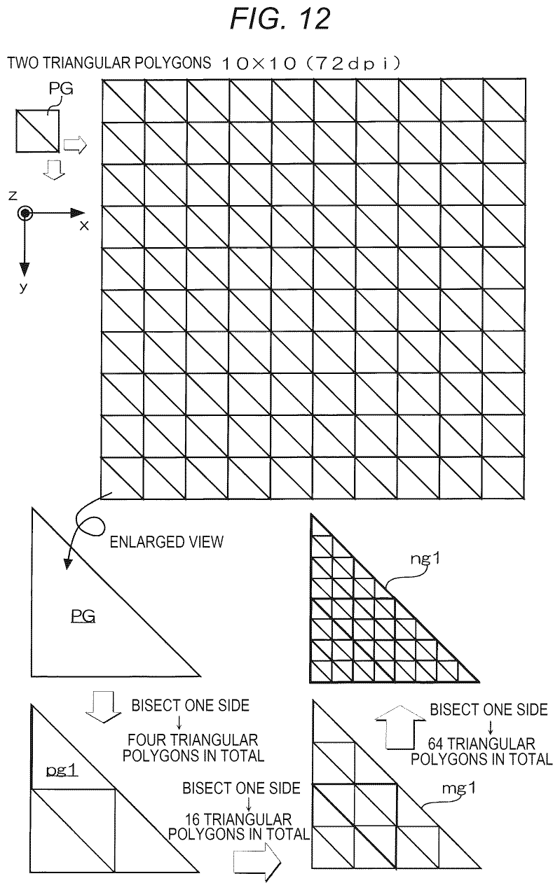

An example of the simplest polygon is shown in FIG. 12. Here, vertical and horizontal resolution of the print medium MT is, for example, 72×72 dpi, and in order to represent the vertical and horizontal resolution by polygons of a 3D model, two triangular polygons PG shown in the upper left of the drawing are arranged in one of the sections constituting a plane. As a result, the print medium MT such as photographic paper can be represented by six vertices. In practice, since two of the six vertices can be used in common, there are actually four vertices. An example is shown in which ten combinations of such two triangular polygons are arranged in X and Y directions to form a plane. In the displacement mapping POD, a vertex position of such a triangular polygon is displaced in a Z direction to achieve a bump representation by rendering.

In order to represent a thickness of ink on the print medium MT, vertices of a polygon at a portion where the ink is printed are moved, but when the number of polygons is small, the movement of the vertices along a boundary of a character is small, and as shown in the upper part of FIG. 11, the bump representation is hardly observed. Therefore, the displacement mapping POD is executed after a polygon is divided by the tessellation processing POT to increase the number of polygons. An example of rendering a result of the displacement mapping POD is shown in a lower part of the drawing. Here, the number of polygons is increased by 16 times. A lower part of FIG. 12 shows an example of a method of increasing the number by dividing a polygon. An original triangular polygon PG can be divided into four similar triangular polygons pg1 by bisecting each side of the original triangular polygon PG. Further, each small polygon pg1 can be divided into 4 small polygons mg1 by bisecting each side of the small polygon pg1. The small polygon mg1 has a size of 1/16 of a size of the original polygon PG.

A preview screen shown in the lower part of FIG. 11 shows a rendering result obtained in the displacement mapping POD by increasing the number of polygons by 16 times. In this stage, although the number of polygons is increased, the number is still insufficient from the viewpoint of resolution, and when vertices of polygons present at positions corresponding to the character string UVP are displaced, a distorted model ring is formed when viewed from an original shape as shown in the drawing. Therefore, when the small polygon mg1 is further divided into four minute polygons ng1, a size of the minute polygon ng1 is 1/64 of the size of the original triangular polygon PG. When the polygon is divided to this size, the number of vertices sufficient to reproduce a shape of the character string UVP in the displacement mapping POD using the displacement map DM can be prepared, and a rendering result shows sufficient shape reproducibility as shown in a lower part of FIG. 10. The minute polygon ng1 may be further divided into four polygons, and a polygon having a size of 1/256 of the size of the original triangular polygon PG may be used. The polygon is not limited to being divided into four small polygons, and may be divided into two small polygons, three small polygons, or five or more small polygons, and shapes of division polygons are not limited to the same or similar shapes, and may be any shape such as shapes of different sizes or different shapes. The final number of division polygons viewed from the original shape is not limited to the power of 4 as described above. As described above with reference to the formula (1), the final number of division polygons may be obtained from resolution of an image.

In the present embodiment, a load of the rendering processing and an appearance of bumps of the print medium MT and an appearance of bumps of ink are balanced by selecting a method of a bump representation based on the print condition PJ as described above. When the print medium MT has a thickness or texture such as cloth, or when a thickness of ink is considerably large such as a plurality of times of printing with UV ink or transfer printing using DTFilm, the displacement mapping using the displacement map DM is selected. In the displacement mapping, the tessellation processing POT is executed as necessary on vertices of polygons for forming a surface of the print medium MT or a surface of ink, the number of polygons is increased, and then the vertices of the polygons are moved. Therefore, a 3D structure of a surface can be realistically represented as compared with the normal mapping or the parallax mapping in which texture is simply represented by shading or the like.

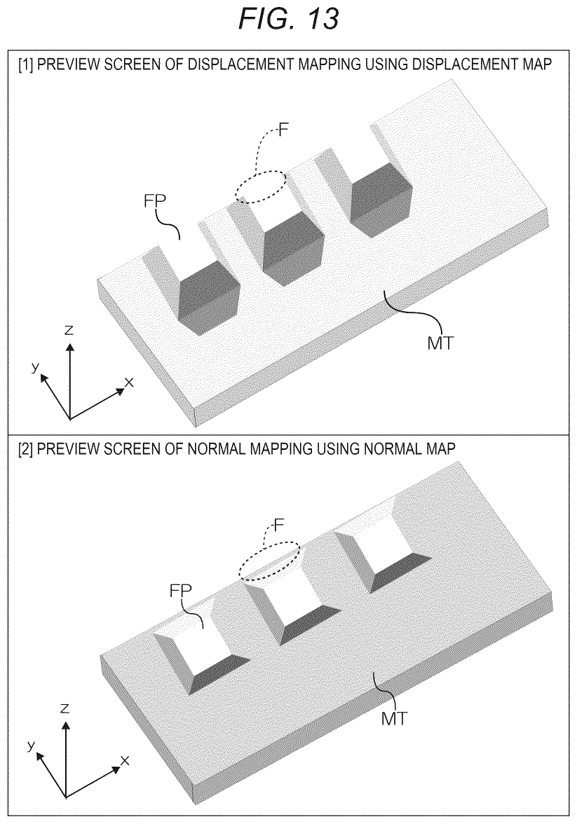

FIG. 13 is a diagram schematically showing an appearance when a bump FP is formed on the print medium MT by performing a plurality of times of printing with clear ink. The bump FP formed at an end of the print medium MT is formed by stacking ink in a truncated quadrangular pyramid shape. Areas of ink layers gradually decrease from the bottom to the top (z direction). An upper part of the drawing shows a preview screen when the displacement mapping using the displacement map DM is executed, and a lower part of the drawing shows a preview screen when the normal mapping using the normal map NM is executed. As shown in the drawing, when the displacement map DM is used, since vertices of polygons are actually displaced, the bumps FP appear to protrude from the print medium MT (portion F in the drawing) at an end portion of the print medium MT when viewed from an oblique viewpoint. On the other hand, when the normal map NM is used, although formation positions of the bumps FP are the same as those in the upper part of the drawing, the bumps FP fall within a range of the print medium MT. This is because the bump representation by the normal map NM does not involve movement of vertices of polygons, that is, ink is not actually raised from a surface of the print medium MT, and only a direction of reflected light is calculated and shading is added assuming that the ink is raised.

### B. Second Embodiment

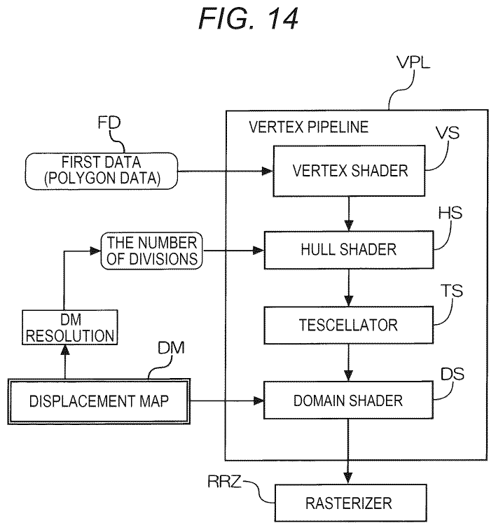

Next, the image processing device 100 according to a second embodiment will be described. The image processing device 100 according to the second embodiment is the same as that in the first embodiment except for a configuration of the vertex pipeline VPL of the rendering execution unit 121. The configuration of the vertex pipeline VPL in the second embodiment is shown in FIG. 14. In the second embodiment, the tessellation processing POT is executed in the rendering execution unit 121, specifically, in the vertex pipeline VPL. As shown in the drawing, the vertex pipeline VPL of the second embodiment includes a Hull shader HS, a tessellator TS, and a domain shader DS from the vertex shader VS to the rasterizer RRZ.

Polygon data included in the first data FD is input to the vertex shader VS. Coordinate data and the like of vertices of a large number of polygons for forming a surface of the print medium MT are input to the vertex shader VS. The Hull shader HS sets the number of divisions of polygons in the vertex pipeline VPL. The Hull shader HS inputs the number of divisions from the outside, which may be the number of divisions determined based on resolution of the displacement map DM or the number of divisions set by a user, as described above with reference to FIG. 4. The Hull shader HS instructs the tessellator TS to divide an initial polygon input to the vertex shader VS using the number of divisions. A function of the tessellator TS is the same as that of the tessellation processing POT described with reference to FIG. 4.

Since a large number of polygons whose sizes are reduced by dividing polygons are obtained, coordinates of vertices of division polygons are set by the domain shader DS. At this time, the displacement mapping POD is also executed. Coordinates of vertices of a large number of small polygons having division sizes are set according to bumps on a surface of the print medium MT to be represented, bumps caused by a thickness of ink to be printed, and the like. As a result, instead of horizon mapping by reflection of light simply based on a normal of a surface, a bump representation is performed by displacing vertices of polygons.

In the configuration shown as the second embodiment, the function of the tessellation processing POT is executed in the rendering execution unit 121, and the displacement mapping POD using the displacement map DM can be executed in a similar manner to that in the first embodiment. Therefore, by selecting a method of a bump representation based on the print condition PJ, it is possible to achieve all the same effects as those of the first embodiment such as balancing between the load of the rendering processing and the appearance of a bump of the print medium MT and a bump of the ink.

### C. Third Embodiment

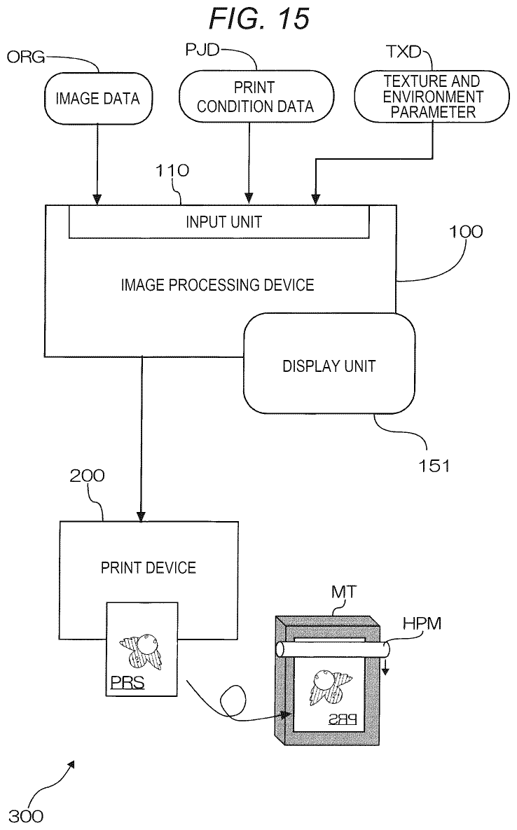

In the first and second embodiments described above, the print medium MT and the image ORG to be printed on the print medium MT are virtual objects treated in the image processing device 100, are rendered using various types of data, and are displayed as a preview image on the image display unit 151 including texture. In contrast, an image print system 300 that actually performs printing using the image processing device 100 will be described in the third embodiment. FIG. 15 is a schematic configuration diagram showing a configuration of the image print system 300. The image print system 300 includes the image processing device 100 described in the first and second embodiments, the image display unit 151 that displays a preview image, and a print device 200 that performs printing. The image data ORG, print condition data PJD for designating a type of the print medium MT, a print method, and the like, and a texture and environment parameter TXD are input to the image processing device 100 via an input unit 110. The print condition data PJD includes data such as a type of the print medium MT or a type of ink used for printing, which is stored in the print condition database 50, and the number of times of printing. The texture and environment parameter TXD includes various types of information necessary for preview, such as illumination information LGT, in addition to the texture parameter TXT. Contents of these pieces of data were described as the configuration and the operation of the rendering execution unit 121.

The print device 200 prints an image on various print media MT using ink such as dye ink, pigment ink, or UV ink as necessary. The print medium MT includes not only paper such as plain paper but also fabric or the like. When fabric or the like is used, direct textile printing may be performed, but a method of performing one printing on transfer paper or the like and transferring onto the print medium MT is also practical. The UV ink is ink of a type that is cured by ultraviolet rays (UV), and thermosetting ink that is cured by heating can also be applied as similar ink.

Transfer printing is performed in the following procedure. First, ink is attached to a recording surface of transfer paper PRS by printing performed by the print device 200. Then, the transfer paper PRS and the print medium MT are heated in a state where the recording surface of the transfer paper PRS is pressed against the print medium MT. As a result, an image is printed on an object by thermal transfer. The transfer printing includes sublimation transfer, DTFilm transfer, and the like. When such transfer printing is performed, printing can be performed on various media other than paper, which is the print medium MT. For example, printing can be performed on various media such as fabric, leather, vinyl fabric, bags obtained by sewing these materials, shoes, sewn products such as clothes, ceramics, plastic, glass, and wood. A shape of the print medium MT is not limited to a sheet shape, and the print medium MT may be handled as long as the print medium MT has a shape at which a transfer sheet can be placed, such as a plate shape, a cylindrical shape, or an angular shape.

In the present embodiment, an example of sublimation transfer will be described. When it becomes a state where a desired printed material is obtained by performing rendering using the image processing device 100 and previewing a bump representation of a surface of the print medium MT and checking the preview, a user prints a previewed image on the transfer sheet PRS using the print device 200. The print device 200 inverts printing image data PIM received from the image processing device 100 and horizontally inverts a printing image. The horizontally inverted image is printed on a recording surface of the transfer paper PRS. The recording surface is a surface of the transfer paper PRS. The printed transfer paper PRS and the print medium MT are heated in a state where the recording surface of the printed transfer paper PRS is pressed against a surface of the print medium MT. For thermal transfer, a hot press machine HPM corresponding to a shape of the print medium MT is used. When an object to be printed is fabric or the like, a flat press machine is used. When an object to be printed is a mug, glass, or the like having a cylindrical shape, a mug press machine is used. When an object to be printed is a three-dimensional object such as a smartphone case, a vacuum press machine is used. As a result of the transfer processing, a product having an image printed on a surface is obtained.

### D. Other Embodiments

(1) The present disclosure can be implemented as an image display device. The image display device includes: an input unit configured to input image data of an image to be printed on a print medium; an acquisition unit configured to acquire a print condition for the print medium; a selection unit configured to select, from the acquired print condition, a method of a bump representation when the image data is processed; and a display execution unit configured to display a preview image of a printed material using the selected method of the bump representation. In this manner, the method of the bump representation can be selected from the print condition, and the printed material can be previewed using the selected method of the bump representation. The image data input unit inputs the image data to be printed by various methods such as communication or via a memory card. The image data may be further edited in an image processing device or a print position on the print medium may be corrected. The image processing device may be integrally configured, or may be distributed and arranged on a network for each function to preview a printed material in cooperation. The preview display only needs to display a state of the printed material on various displays, and the display may be any form of display such as a liquid crystal display, an organic EL display, and a projector.

(2) In the above configuration, the print condition may include at least one of a type of the print medium and a classification of a condition of an image forming material. In this manner, it is possible to select the method of the bump representation suitable for a height of a bump formed by the image forming material according to a height of a bump on the surface of the print medium and the classification of the condition of the image forming material, which vary depending on a type of the print medium. The image forming material may be various materials such as ink, DTFilm, a transfer sheet, and a filament of a 3D printer. The ink may be various kinds of ink such as dye ink, pigment ink, photocurable ink (UV ink), and thermosetting ink.

(3) In the above configuration, the classification of the condition of the image forming material may include a type and an amount of ink used for printing the image. In this manner, it is easy to select a method of a bump representation when the image data is processed according to the height of the bump formed by the image forming material on the print medium corresponding to the image. The classification of the condition of the image forming material can be set according to an ink type such as dye, pigment, and photocurable ink, an ink amount such as the number of times of printing and a difference in a range of ink duty in one printing.

(4) In the above configuration, the type of the print medium and the classification of the condition of the image forming material may be associated with the height of the bump on the print medium on which the image is formed, and the selection unit may select the bump representation according to at least one of the type of the print medium and the classification of the condition of the image forming material. In this manner, it is easy to achieve a representation corresponding to the height of the bump by acquiring the type of the print medium and the classification of the condition of the image forming material, which is a print condition. The type of the print medium and the classification of the condition of the image forming material associated with the height of the bump may be measured in advance and associated with the print condition. In this manner, it is easy to select the method of the bump representation corresponding to the type of the print medium and the classification of the condition of the image forming material associated with the height of the bump.

(5) In the above configurations (1) to (4), the selection unit may select the method of the bump representation according to the height of the bump on the print medium on which the image is formed and a threshold prepared for selecting the method of the bump representation. In this manner, it is only necessary to compare the height and the threshold, and the bump representation can be easily selected. The “height of the bump on the print medium on which the image is formed” at the time of the comparison may refer to that the height of the bump caused by the type of the print medium or the classification of the condition of the image forming material, which is the print condition, may be specified according to the print condition acquired by the acquisition unit by associating the height of the bump with the print condition in advance.

(6) In the above configurations (1) to (5), the acquisition unit may select one print method from a plurality of types of print methods as the print condition, and the selection unit may select the method of the bump representation according to the print method selected from the plurality of types of print methods. In this manner, it is only necessary to select the print method, and the bump representation can be easily selected.

(7) In the above configurations (1) to (6), the selection unit may select at least one of normal mapping, parallax mapping, and displacement mapping as the method of the bump representation. In this manner, it is possible to achieve a wide range of processing from processing with a low load to a bump representation corresponding to an actual shape with a high load. These kinds of processing may be executed by selecting only one of the processing, or may be executed together with the normal mapping, the parallax mapping, and the like.

(8) In the above configurations (1) to (7), the method of the bump representation may include at least the normal mapping and the parallax mapping, and the selection unit may select the normal mapping as the method of the bump representation when the height of the bump on the print medium on which the image is formed is less than a predetermined first threshold, and may select both the normal mapping and the parallax mapping as the methods of the bump representation when the height of the bump is equal to or larger than the first threshold. In this manner, when the height of the bump is small, the normal mapping with a small load can be adopted as the method of the bump representation, and when the height of the bump is large, the normal mapping and the parallax mapping can be selected together as the method of the bump representation, and it is easy to achieve both a processing load and accuracy of the bump representation.

(9) In the above configurations (1) to (8), the selection unit may execute at least the normal mapping of the normal mapping and the parallax mapping as the method of the bump representation when the height of the bump on the print medium on which the image is formed is less than a predetermined second threshold, and may select the displacement mapping as the method of the bump representation when the height of the bump is equal to or larger than the second threshold. In this manner, when the height of the bump is small, processing including the normal mapping with a small load can be adopted as the method of the bump representation, and when the height of the bump is large, the displacement mapping can be selected as the method of the bump representation, and it is easy to achieve both the processing load and the accuracy of the bump representation when the height of the bump is relatively large.

(10) In the above configurations (1) to (9), the selection unit may select at least one of the normal mapping and the parallax mapping as the method of the bump representation when the height of the bump on the print medium on which the image is formed is less than the predetermined first threshold, may select both the normal mapping and the parallax mapping as the methods of the bump representation when the height of the bump is equal to or larger than the first threshold and less than the second threshold that is larger than the first threshold, and may select the displacement mapping as the method of the bump representation when the height of the bump is equal to or larger than the second threshold. In this manner, it is easy to properly use the normal mapping, the parallax mapping, and the displacement mapping according to the height of the bump.

(11) In the above configurations (1) to (10), the method of the bump representation may include at least the displacement mapping, the display execution unit may represent the print medium and the image forming material by a plurality of polygons, and may execute division processing on the polygons when the displacement mapping is executed. In this manner, it is easy to avoid a situation in which reproducibility of a shape becomes insufficient due to a large polygon.

(12) In the above configurations (1) to (11), the number of divisions of the polygons may be determined according to the resolution of the image. In this manner, it is easy to determine the number of divisions.

(13) In the above configurations (1) to (12), the number of divisions of the polygons may be received from the outside. In this manner, a size of a polygon can be made suitable for the sense of feeling of a user, and a feeling of strangeness in appearance regarding a shape can be prevented.

(14) The present disclosure can also be implemented as an image print system. The image print system includes: an input unit configured to input image data of an image to be formed on a print medium using an image forming material; an acquisition unit configured to acquire a print condition that is a condition for printing on the print medium; a selection unit configured to select, from the acquired print condition, a method of a bump representation when the image data is processed; a display execution unit configured to display a preview image of a printed material using the selected method of the bump representation; and a print device configured to print the preview image on the print medium. In this manner, it is possible to preview an appearance including the image to be printed on the print medium before performing printing by the print device, and since the printed material is previewed by the bump representation according to the print condition, it is easy to grasp the printed material to be printed under the print condition.

(15) The present disclosure can also be implemented as a non-transitory computer-readable storage medium storing an image processing program for generating a rendered image of a print medium on which an image is printed. The non-transitory computer-readable storage medium storing an image processing program causes a computer to execute: inputting image data of the image formed on the print medium using an image forming material; acquiring a print condition that is a condition for printing on the print medium; selecting, from the acquired print condition, a method of a bump representation when the image data is processed; and displaying a preview of a printed material using the selected method of the bump representation. In this manner, it is possible to easily preview the printed material using the computer, and since the printed material is previewed by the bump representation according to the print condition, it is easy to grasp the printed material to be printed under the print condition.

(16) In the above-described embodiments, a part of a configuration implemented by hardware may be replaced with software. At least a part of the configuration implemented by software can be implemented by a discrete circuit configuration. When a part or all of the functions according to the present disclosure are implemented by software, the software (computer program) can be provided in the form of being stored in a computer-readable recording medium. The “computer-readable recording medium” is not limited to a portable medium such as a flexible disc or a CD-ROM, and includes internal storage devices in a computer such as various RAMs and ROMs or an external storage device fixed to a computer such as a hard disk. That is, the term “computer-readable recording medium” has a broad meaning including any medium in which a data packet can be fixed, not temporarily.

The present disclosure is not limited to the above embodiments and may be implemented with various configurations without departing from the spirit and scope of the present disclosure. For example, technical features in the embodiments corresponding to technical features in the aspects described in the summary section can be replaced and combined as appropriate in order to solve a part or all of the above problems or in order to achieve a part or all of the above effects. Also, the technical features can be deleted as appropriate, unless described as essential in the present specification.

What is claimed is:

1. An image processing device comprising:
an input unit configured to input image data of an image to be formed on a print medium using an image forming material;
an acquisition unit configured to acquire a print condition that is a condition for printing on the print medium;
a selection unit configured to select, from the acquired print condition, a method of a bump representation when the image data is processed; and
a display execution unit configured to display a preview image of a printed material using the selected method of the bump representation.

2. The image processing device according to claim 1, wherein
the print condition includes at least one of a type of the print medium and a classification of a condition of the image forming material.

3. The image processing device according to claim 2, wherein
the classification of the condition of the image forming material includes a type and an amount of ink used for printing the image.

4. The image processing device according to claim 2, wherein
the type of the print medium and the classification of the condition of the image forming material are associated with a height of a bump on the print medium on which the image is formed, and
the selection unit selects the bump representation according to at least one of the type of the print medium and the classification of the condition of the image forming material.

5. The image processing device according to claim 1, wherein
the selection unit selects the method of the bump representation according to a height of a bump on the print medium on which the image is formed and a threshold prepared for selecting the method of the bump representation.

6. The image processing device according to claim 1, wherein
the acquisition unit selects one print method from a plurality of types of print methods as the print condition, and
the selection unit selects the method of the bump representation according to the print method selected from the plurality of types of print methods.

7. The image processing device according to claim 1, wherein
the selection unit selects at least one of normal mapping, parallax mapping, and displacement mapping as the method of the bump representation.

8. The image processing device according to claim 7, wherein
the method of the bump representation includes at least the normal mapping and the parallax mapping, and
the selection unit selects the normal mapping as the method of the bump representation when a height of a bump on the print medium on which the image is formed is less than a predetermined first threshold, and selects both the normal mapping and the parallax mapping as the methods of the bump representation when the height of the bump is equal to or larger than the first threshold.

9. The image processing device according to claim 7, wherein
the selection unit executes at least the normal mapping of the normal mapping and the parallax mapping as the method of the bump representation when a height of a bump on the print medium on which the image is formed is less than a predetermined second threshold, and selects the displacement mapping as the method of the bump representation when the height of the bump is equal to or larger than the second threshold.

10. The image processing device according to claim 7, wherein
the selection unit
selects at least one of the normal mapping and the parallax mapping as the method of the bump representation when a height of a bump on the print medium on which the image is formed is less than a predetermined first threshold,
selects both the normal mapping and the parallax mapping as the methods of the bump representation when the height of the bump is equal to or larger than the first threshold and less than a second threshold that is larger than the first threshold, and
selects the displacement mapping as the method of the bump representation when the height of the bump is equal to or larger than the second threshold.

11. The image processing device according to claim 1, wherein
the method of the bump representation includes at least displacement mapping, and
the display execution unit represents the print medium and the image forming material by a plurality of polygons, and executes division processing on the polygons when the displacement mapping is executed.

12. The image processing device according to claim 11, wherein
the number of divisions of the polygons is determined according to the resolution of the image.

13. The image processing device according to claim 11, wherein
the number of divisions of the polygons is received from outside.

14. An image print system comprising:
an input unit configured to input image data of an image on a print medium;
an acquisition unit configured to acquire a print condition that is a condition for printing on the print medium;
a selection unit configured to select, from the acquired print condition, a method of a bump representation when the image data is processed;
a display execution unit configured to display a preview image of a printed material using the selected method of the bump representation; and
a print device configured to print the preview image on the print medium.

15. A non-transitory computer-readable storage medium storing an image processing program for generating a rendered image of a print medium on which an image is printed, the image processing program causing a computer to execute:
inputting image data of the image to be formed on the print medium using an image forming material;
acquiring a print condition that is a condition for printing on the print medium;
selecting, from the acquired print condition, a method of a bump representation when the image data is processed; and
displaying a preview image of a printed material using the selected method of the bump representation.
